(19) United States
(12) Patent Application Publication
(10) Pub. No.: US 2013/0321841 A1
(43) Pub. Date: Dec. 5, 2013

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: Junko Nakajima, Yokohama-shi (JP)

(73) Assignee: CANON KABUSHIKI KAISHA, Tokyo (JP)

(21) Appl. No.: 13/903,855

(22) Filed: May 28, 2013

(30) Foreign Application Priority Data
May 30, 2012 (JP) 2012-122904

(51) Int. Cl. H04N 1/21; H04N 1/44; H04N 1/00

(52) U.S. Cl. CPC H04N 1/21; H04N 1/00856; H04N 1/4406; H04N 1/00474
USPC 358/1.13; 358/1.14

(57) ABSTRACT

An image forming apparatus includes an obtaining unit configured to obtain document data to be printed, a determination unit configured to determine whether printing of the document data is permitted based on authentication information received from a user, in a case where a security setting is set on the document data, a printing unit configured to print bitmap image data, which is generated from the document data, when the determination unit determines that the printing of the document data is permitted, a storage unit configured to store the bitmap image data in association with a history of printing of the document data, and a control unit configured to, when a reprint request of the document data is input based on the history, control the printing unit to print the bitmap image data stored in the storage unit in response to reception of the authentication information from the user again.

### BACKGROUND

1. Field of the Disclosure

Aspects of the present invention relates to an image forming apparatus and a method for controlling the same, and, more particularly, to an image forming apparatus capable of performing reprinting by managing a print history and a method for controlling the same.

2. Description of the Related Art

In recent years, in an image forming apparatus such as a multifunction peripheral, document data stored in memory media or a file server on a network can be printed in addition to image data read by a scanner device and print data received from a personal computer. As the image forming apparatus is increased in performance and multifunctionalized, a user can perform printing in various formats while a setting becomes complicated. If data, which has been printed once by such an image forming apparatus, is reprinted in the same setting, input of the data and a complicated print setting need to be performed again. Therefore, processing is complicated, and an output result may differ from that in initial printing. Therefore, a reprinting function of storing rasterized image data, which has been generated from input data, in a hard disk within the image forming apparatus when printing is performed, storing the generated image data, together with a print setting, in association with a print history, and reusing the rasterized image data again when an instruction to perform reprinting is issued has been discussed. The reprinting function enables the user to easily perform the reprinting and further to shorten an output time because the rasterized image data is used.

On the other hand, input data serving as a target of a reprinting function also includes document data on memory media and a network file server as described above, and the document data includes a document with a security setting that requires authentication with a password in reading and print output. For example, an encrypted Portable Document Format (PDF) document is an example of the document with a security setting. If a document with a security setting is printed, the document needs authentication with a password or to be decrypted using a predetermined decryption key when the document has been encrypted. If the password has not yet been entered or an erroneous password is entered, the print output needs to be inhibited. If password authentication is successful once, so that the document with a security setting is permitted to be printed, however, the document can be printed without entering the password when reprinted by the reprinting function. Thus, the security of information protection becomes an issue.

Therefore, Japanese Patent Application Laid-Open No. 2010-97350 discusses a printing system for causing a user to designate a confidential level when printing is performed to maintain security, to determine whether image data is stored in a storage device or discarded depending on the confidential level.

However, in Japanese Patent Application Laid-Open No. 2010-97350, the image data at a high confidential level cannot be reprinted using a reprinting function because such image data is not stored in the storage device. Therefore, in Japanese Patent Application Laid-Open No. 2010-97350, convenience is hampered while security of information protection can be maintained.

Further, if the data at a high confidential level is stored in the storage device in the same data format as that during initial printing, an output time during reprinting cannot be shortened.

### SUMMARY OF THE INVENTION

Aspects of the present invention are directed to an image forming apparatus for improving convenience of a reprinting function while maintaining security.

According to an aspect of the present invention, an image forming apparatus includes an obtaining unit configured to obtain document data to be printed, a determination unit configured to determine whether printing of the document data is permitted based on authentication information received from a user, in a case where a security setting is set on the document data, a printing unit configured to print bitmap image data, which is generated from the document data, when the determination unit determines that the printing of the document data is permitted, a storage unit configured to store the bitmap image data in association with a history of printing of the document data, and a control unit configured to, when a reprint request of the document data is input based on the history, control the printing unit to print the bitmap image data stored in the storage unit in response to reception of the authentication information from the user again.

Further features of the present disclosure will become apparent from the following description of exemplary embodiments with reference to the attached drawings.

### BRIEF DESCRIPTION OF THE DRAWINGS

FIG. 1 illustrates a network configuration.

FIG. 2 is a block diagram illustrating a schematic configuration of a multifunction peripheral.

FIG. 3 is a block diagram illustrating a software configuration of the multifunction peripheral.

FIG. 4 is a flowchart illustrating an example of the procedure for print processing and history information management.

FIG. 5 illustrates an example of a screen displayed on an operation unit.

FIG. 6 illustrates an example of a history information management table.

FIG. 7 is a flowchart illustrating an example of the procedure for reprint processing.

### DESCRIPTION OF THE EMBODIMENTS

Exemplary embodiment of the present invention is described below with reference to the drawings.

<Network Configuration>

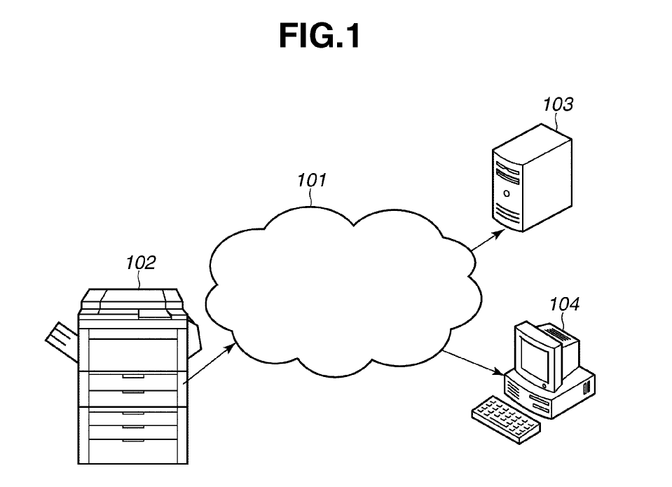

FIG. 1 illustrates a network configuration to which a multifunction peripheral serving as an image forming apparatus according to an exemplary embodiment of the present invention is applicable. In FIG. 1, a network 101 supports a transmission control protocol (TCP)/Internet protocol (IP), for example. The network 101 is connected to a multifunction peripheral 102, a file server 103, and a client computer 104. The client computer 104 is used by a general user.

The multifunction peripheral 102 can print-output document data stored in the client computer 104 and the file server 103. For example, the client computer 104 stores document data to be used by an application and sends print data using a printer driver to the multifunction peripheral 102 via the network 101, so that the multifunction peripheral 102 can print-output the document data. The multifunction peripheral 102 can acquire the document data stored in the file server 103 via the network 101 and print-output the acquired document data in response to a request to print the document data.

The components are illustrated as a general configuration in a conceptual diagram. However, there may be included a plurality of computers and a plurality of multifunction peripherals used by the general user. Not the multifunction peripheral but a device, such as a printer, alone may be connected to the network 101.

<Configuration of Multifunction Peripheral 102>

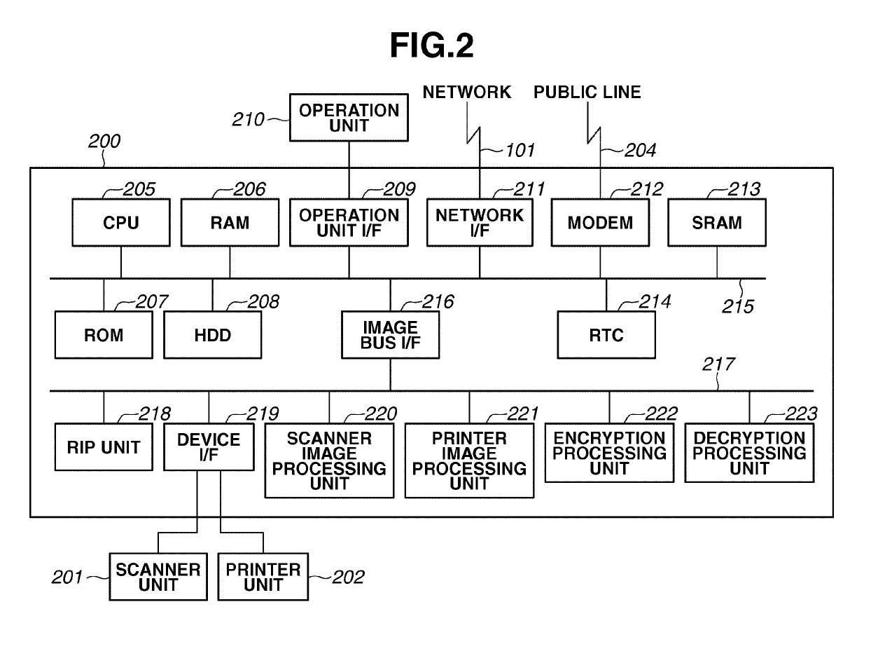

FIG. 2 is a block diagram illustrating a schematic configuration of the multifunction peripheral 102 according to the present exemplary embodiment. A controller unit 200 is connected to a scanner unit 201 serving as an image input device and a printer unit 202 serving as an image output device while being connected to the network 101 and a public line 204 to input/output image information and device information.

A central processing unit (CPU) 205 is a controller that controls the entire multifunction peripheral 102. A random access memory (RAM) 206 is a system work memory for the CPU 205 to operate, and is also an image memory for temporarily storing image data. A read-only memory (ROM) 207 is a boot ROM, and stores a boot program for a system. A hard disk drive (HDD) 208 stores system software, an application, and image data.

An operation unit interface (I/F) 209 is an interface with an operation unit 210 including a touch panel, and outputs image data to be displayed on the operation unit 210 to the operation unit 210. The operation unit I/F 209 also functions to transmit information, which has been input by a user who uses the multifunction peripheral 102 in the operation unit 210, to the CPU 205. A network I/F 211 is connected to the network 101, to input/output information. A modulator-demodulator (MODEM) 212 is connected to the public line 204, to input/output information. A static random access memory (SRAM) 213 is a nonvolatile recording medium capable of performing a high-speed operation. A real-time clock (RTC) 214 continues to count a current time even while power is not applied to the controller unit 200. The above-mentioned devices are arranged on a system bus 215.

An image bus I/F 216 is a bus bridge that connects the system bus 215 and an image bus 217 for transferring image data at high speed and converts a data structure. The image bus 217 includes a Peripheral Components Interconnect (PCI) bus or an Institute of Electrical and Electronics Engineers (IEEE) 1394 bus. The following devices are arranged on the image bus 217. A raster image processor (RIP) unit 218 rasterizes a page description language (PDL) code into a bitmap image. A device I/F 219 connects the controller unit 200 to the scanner unit 201 and the printer unit 202, which serve as an image input/output device, and performs synchronous/asynchronous conversion of image data. A scanner image processing unit 220 corrects, processes, and edits the input image data. A printer image processing unit 221 performs printer correction and resolution conversion for the print-output image data. An encryption processing unit 222 encrypts input data including the image data. A decryption processing unit 223 decrypts the encrypted data.

<Software Configuration of Multifunction Peripheral 102>

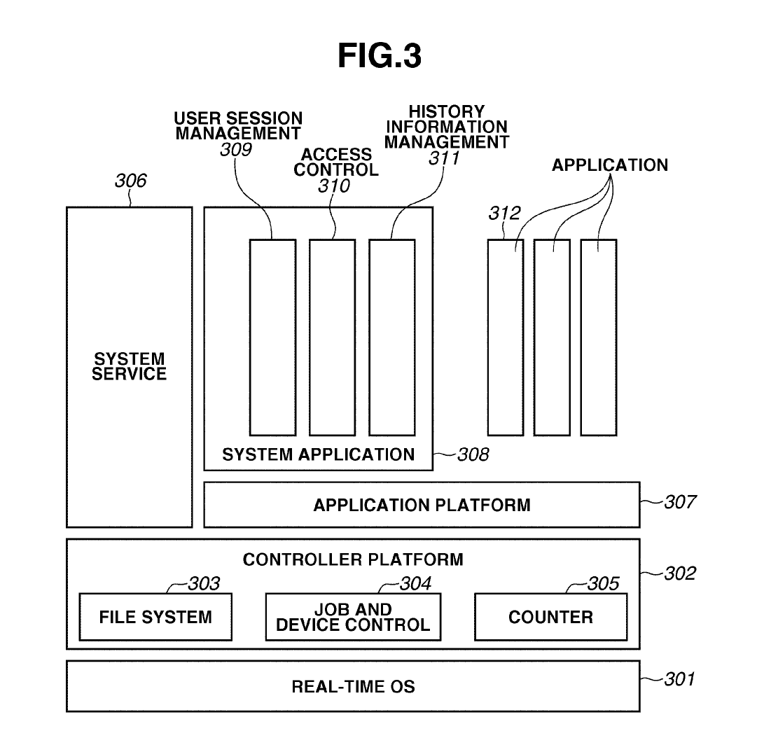

FIG. 3 is a block diagram illustrating a software configuration of the multifunction peripheral 102 according to the present exemplary embodiment. The software is mounted on the controller unit 200 in the multifunction peripheral 102. Each of blocks illustrated in FIG. 3 indicates a function to be implemented by executing software (a program) built-in in the multifunction peripheral 102 and processed by the controller unit 200. The software is mounted as firmware, and is executed by the CPU 205.

A real-time operating system (OS) 301 provides a service and a framework for management of various types of resources optimized to control a built-in system for software running thereon. The service and the framework for management of the various types of resources to be provided by the real-time OS 301 include multitask management for substantially operating a plurality of processes in parallel by managing a plurality of execution contexts for processing by the CPU 205, and inter-task communication for implementing synchronization and data exchange between tasks. Further, the service and the framework include memory arrangement, interrupt management, various types of device drivers, and a protocol stack implementing various types of protocol processing, such as local interfacing, networking, and communication.

A controller platform 302 includes a file system 303, a job and device control 304, and a counter 305.

The file system 303 is a mechanism for storing data constructed on a storage device such as the HDD 208 and the RAM 206, and is used to spool a job handled by the controller unit 200 and store various types of data. The job and device control 304 controls a hardware resource for the multifunction peripheral 102, and controls a job using basic functions (printing, scanning, communication, image conversion, etc.) mainly provided by hardware of the multifunction peripheral 102. The counter 305 manages an expiration date for each application and counter values for printing and scanning, which are stored in the SRAM 213.

A system service 306 is a module for monitoring an operational status of the multifunction peripheral 102 and downloading software and a license from a software distribution server via the network 101.

An application platform 307 is middleware for enabling a system application 308 and an addable application 312 described below to use respective mechanisms for the real-time OS 301 and the controller platform 302.

The system application 308 includes a user session management 309, an access control 310, and a history information management 311.

The user session management 309 is a module for managing a user property including user information and user authority in response to login or logout of the user.

The access control 310 is a security module for permitting and inhibiting access to a job and various types of resources based on the user authority and a security setting set in data. The access control 310 determines, when access restriction for each user is set on a resource to be accessed (e.g., document data to be printed), whether access to the resource is permitted depending on the user property that can be acquired from the user session management 309. If the access restriction is set with a password in the resource to be accessed, a request to enter the password is issued, to determine whether access can be made depending on a password authentication result.

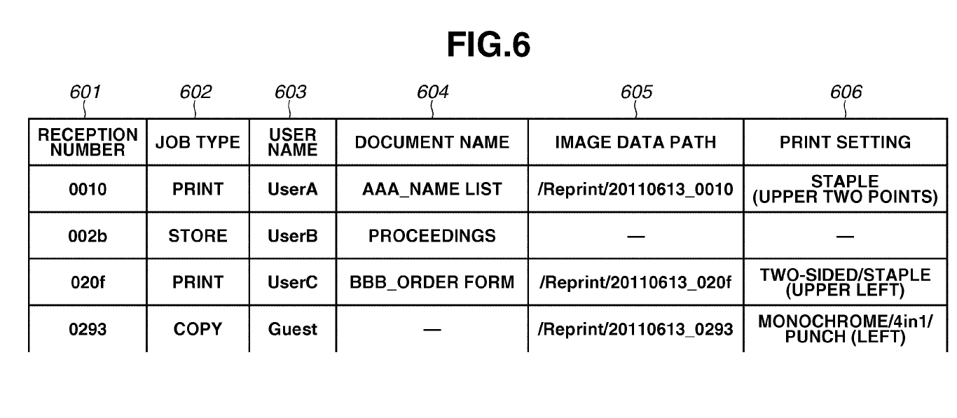

The history information management 311 is a module for managing basic job information including a type and a document name of a job, which has already been executed, as a history. More specifically, a history information management table 600 illustrated in FIG. 6 is stored in the HDD 208, and a user name 603, a document name 604, an image data path 605, and a print setting 606, which are used in a reprinting function described below, together with a job reception number 601 and a job type 602, are stored in association with image data.

The application 312 is a module for providing various types of functions, which are to be implemented by the multifunction peripheral 102, for a user for displaying a menu screen on the operation unit 210 and receiving input from the user.

<Procedure for Print Processing and History Information Management>

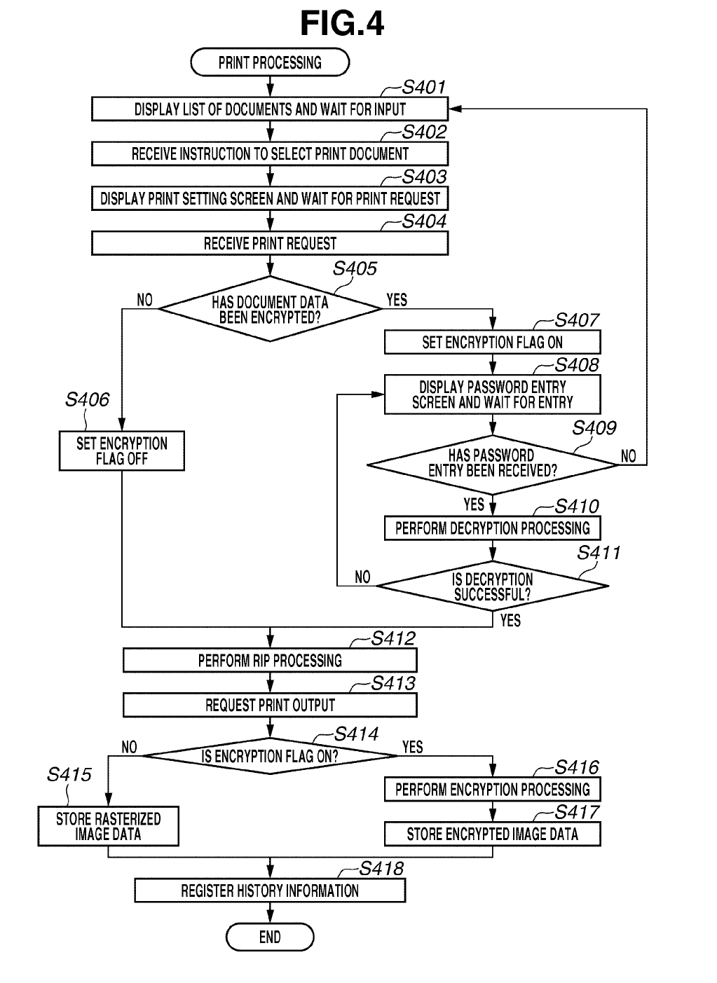

FIG. 4 is a flowchart illustrating an example of the procedures, which are executed by the CPU 205 in the multifunction peripheral 102, for printing document data and for managing a print history by the multifunction peripheral 102 according to the present exemplary embodiment. The flowchart illustrated in FIG. 4 is started when the user has issued an instruction to start a printing function for printing a stored document by the multifunction peripheral 102.

When the user first issues the instruction to start the printing function on the operation unit 210, the processing proceeds to step S401. In step S401, the CPU 205 displays a list of printable document data on the operation unit 210, and waits for the subsequent instruction input from the user. The displayed list of document data includes a file name of the document data and a thumbnail image generated from the document data.

The document data, which is specified by identification data (ID), out of the document data displayed as a list is previously stored in the HDD 208 in the present exemplary embodiment. However, document data within the file server 103 connected via the network 101 and removable media, such as a universal serial bus (USB) memory connected via the device I/F 219, may be acquired and printed. In other words, the document data may be stored in any type of storage device.

A format of the document data stored in the storage device may include various formats, such as PDF, Tag Image File Format (TIFF), Extensible Markup Language (XML) Paper Specification (XPS), and Office Open Extensible Markup Language (OOXML).

In step S402, the operation unit 210 sends, when the operation unit 210 receives an instruction to select the document data, to be printed out of the plurality of document data displayed as a list, the ID of the selected document data to the CPU 205.

In step S403, the CPU 205 displays a print setting screen for setting printing of document data on the operation unit 210, and waits until the user issues a request to perform printing.

In step S404, the operation unit 210, which has received the request to perform printing from the user, notifies the CPU 205 of the request. In step S405, the CPU 205 refers to the ID of the document data, which has been received in step S402, obtains the document data to be printed from the HDD 208, and determines whether the document data has been encrypted. If the document data specified by the ID is in a PDF, the CPU 205 confirms whether the document data is in an encrypted PDF. If the document data is in the encrypted PDF, it is determined that the answer is in the affirmative in step S405.

If it is determined that the document data has not been encrypted (NO in step S405), the processing proceeds to step S406. In step S406, the CPU 205 sets an encryption flag to be stored in the RAM 206 to OFF, and performs processes in step S412 and the subsequent steps. If it is determined that the document data has been encrypted (YES in step S405), the processing proceeds to step S407. In step S407, the CPU 205 sets the encryption flag to be stored in the RAM 206 to ON.

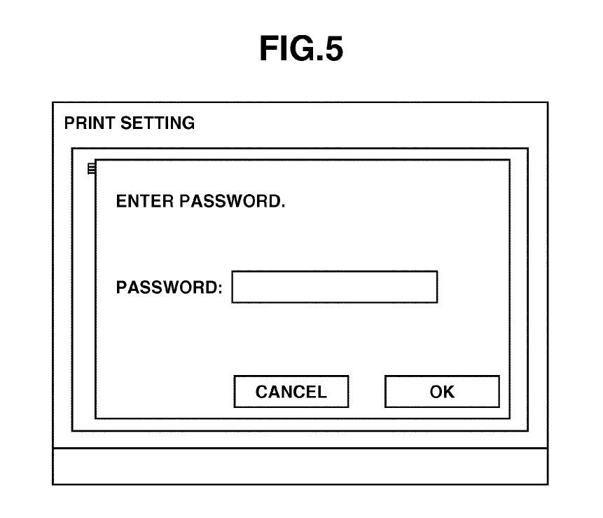

In step S408, the CPU 205 displays a password entry screen illustrated in FIG. 5 on the operation unit 210, and waits for an entry of a password serving as authentication information by the user.

In step S409, the CPU 205 determines whether the operation unit 210 has received the password entry by the user on the screen illustrated in FIG. 5. If the operation unit 210 has received an instruction to cancel the password entry (NO in step S409), the processing returns to step S401. If the operation unit 210 has received the password entry (YES in step S409), the operation unit 205 sends the received password to the CPU 205. In step S410, the CPU 205 decrypts the document data using the password, which has been received in step S409, as a decryption key of the data.

In step S411, the CPU 205 checks data, which has been decrypted based on the password, and determines whether the decryption is successful. If it is determined that the decryption is unsuccessful (NO in step S411), the processing returns to step S408. If it is determined that the decryption is successful (YES in step S411), the CPU 205 performs processes in step S412 and the subsequent steps.

In step S412, the CPU 205 requests RIP processing to the RIP unit 218, and generates rasterized image data. The rasterized image data is bitmap data serving as image data obtained by converting document data. In step S413, the CPU 205 requests print output from the printer unit 202 via the device I/F 219 using the rasterized image data that has been generated in step S412. In step S414, the CPU 205 confirms whether an encryption flag stored in the RAM 206 is ON. If it is determined that the encryption flag is OFF (NO in step S414), the processing proceeds to step S415. In step S415, the CPU 205 stores the rasterized image data, which has been generated in step S412, in the HDD 208 without particularly adding a security setting to the rasterized image data, and performs processes in step S418 and the subsequent steps. If it is determined that the encryption flag is ON (YES in step S414), the processing proceeds to step S416. In step S416, the CPU 205 encrypts the rasterized image data that has been generated in step S412.

At this time, a key used to encrypt the rasterized image data is the password that has been received in step S409. More specifically, the password, which has been used as the decryption key during the initial printing, is diverted as the encryption key during the reprinting. The password used when the document data is printed is thus diverted as the encryption key for the rasterized image data, so that the user need not separately remember a password for the reprinting.

However, it takes time to encrypt/decrypt all the rasterized image data with the above-mentioned password. Therefore, only some pieces of the data may be encrypted. Alternatively, access restriction may be put on a predetermined storage area in the HDD 208 with the password, which has been received in step S409, to store the rasterized image data in the storage area.

In step S417, the CPU 205 stores the rasterized image data, which has been encrypted in step S416, in the HDD 208.

In step S418, the CPU 205 registers a value in each of fields of the history information management table 600 as a print history. More specifically, an ID of a job executed for the document data, which has been received in step S402, is registered in the field “reception number 601”. The type of the job is registered in the field “job type 602”. Since the executed job is a print job, a value “print” is registered. If the executed job is a job for storing the input document data in the HDD 208, a value “store” is registered. If the executed job is a job for copying, a value “copy” is registered. A name of a user who has executed the job is registered in the field “user name 603”. Since information about a user who has logged in to the multifunction peripheral 102 is managed with an application for the user session management 309, as described above, the CPU 205 registers information about the log-in user in the field “user name 603”.

A file name of the document data is registered in the field “document name 604”. A path of the rasterized image data, which has been stored in step S415 or S417, is registered in the field “image data path 605”. The print setting, which has been set on the document data in step S403, is registered in the field “print setting 606”. The encryption flag indicating whether the rasterized image data is encrypted may also be registered in the table illustrated in FIG. 6.

<Procedure for Reprint Processing>

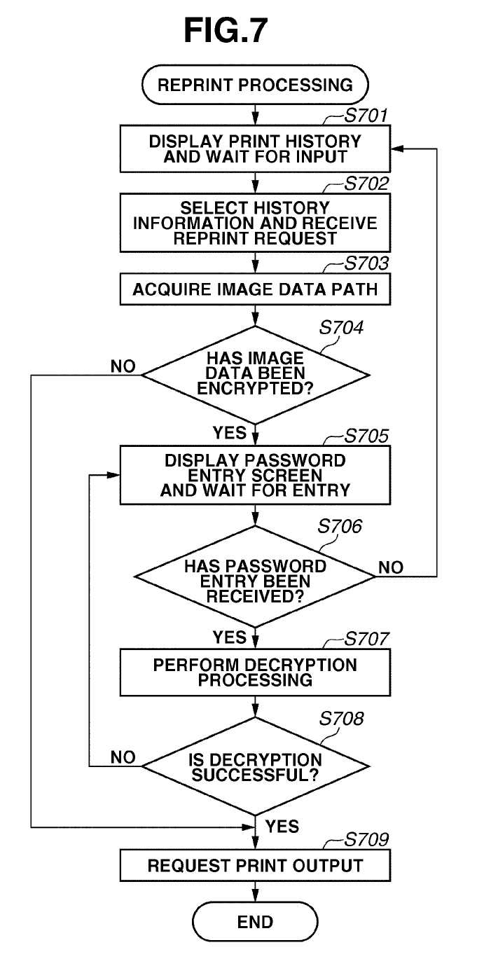

FIG. 7 is a flowchart illustrating an example of the procedure for reprinting by the multifunction peripheral 102 according to the present exemplary embodiment, which is executed by the CPU 205 in the multifunction peripheral 102. The flowchart illustrated in FIG. 7 is started when the user has selected a reprinting function in the multifunction peripheral 102. The use of the reprinting function enables the same printing result as that in the print output in FIG. 4 without performing a complicated print setting again.

When the user first issues an instruction to use the reprinting function via the operation unit 210, the processing first proceeds to step S701. In step S701, the CPU 205 displays a list of print histories on the operation unit 210, and waits for the subsequent instruction input by the user. As the print histories to be displayed, history information, in which the job type 602 is “print”, are acquired from the history information management table 600 illustrated in FIG. 6, and are displayed as a list on the operation unit 210. At this time, a job reception number, a document name, and a print setting are displayed as a list.

In step S702, the operation unit 210 sends, when the operation unit 210 receives selection of the history information for performing reprinting from the list of document data by the user and an instruction to perform reprinting, the selected history information and a request to perform reprinting to the CPU 205.

In step S703, the CPU 205 acquires a rasterized image data path corresponding to the history information, which has been received in step S702, from the history information management table 600.

In step S704, the CPU 205 determines whether rasterized image data to be specified by the rasterized image data path, which has been acquired in step S703, has been encrypted. If it is determined that the rasterized image data has not been encrypted (NO in step S704), the CPU performs processes in step S709 and the subsequent steps using the image data to be specified by the rasterized image data path that has been acquired in step S703. If it is determined that the rasterized image data has been encrypted (YES in step S704), the processing proceeds to step S705. In step S705, the CPU 205 displays a password entry screen illustrated in FIG. 5 on the operation unit 210, and waits for an entry by the user.

In step S706, the CPU 205 determines whether the operation unit 210 has received the password entry by the user. If the operation unit 210 has received a cancel instruction from the user (NO in step S706), the processing returns to step S701. If the operation unit 210 has received the password entry (YES in step S706), the operation unit 210 sends a password to the CPU 205.

In step S707, the CPU 205 decrypts the image data using the password that has been received in step S706. In step S708, the CPU 205 determines whether decryption processing is successful. If the CPU 205 determines that the decryption processing is unsuccessful (NO in step S708), the processing returns to step S705. If the CPU 205 determines that the decryption processing is successful (YES in step S708), the CPU 205 performs processes in step S709 and the subsequent steps using the decrypted image data. In step S709, the CPU 205 requests print output from the printer unit 202 via the device I/F 219 using the image data.

If the document data, which has been encrypted with the password, has been printed by the above-mentioned processing, the image data, which has been decrypted and subjected to RIP processing, is encrypted again, and is then stored in the HDD 208. Therefore, document data, to which a security setting has been added, can be reprinted from the print history while a request to authenticate the user by the password is also issued during the reprinting. Therefore, the user can benefit from the convenience of the reprinting function while maintaining security. Since not data, which is to be subjected to RIP processing, but data, which has been subjected to RIP processing, is stored in a hard disk, an output time during reprinting can also be shortened. Since document data, to which a security setting has been added (i.e., confidential document data) is stored after being encrypted, a risk that the stored document data is accessed by a malicious third person can be reduced.

In the description of the present exemplary embodiment, the document data, which has been encrypted with the authentication information, such as the password, is handled as an example of the document data, to which the security setting has been added. However, the document data, to which the security setting has been added, also includes document data, to which an access restriction has been put with a password, and document data, printing of which is to be started in response to an entry of a valid password.

While a case where the document data, which has been encrypted with the password, is decrypted and subjected to RIP processing, and is encrypted using the same password as a key after being subjected to RIP processing has been handled in the above-mentioned exemplary embodiment, the same password need not be used. In the case, the document data may be encrypted using a key that is known by only a user who has performed print processing. Alternatively, a key for decryption may be notified to the user after print processing has been performed.

While a case where the document data, which has been encrypted with the password, is subjected to RIP processing, and the rasterized image data is then encrypted again has been handled in the above-mentioned exemplary embodiment, the rasterized image data need not be encrypted but may be stored in a storage area protected with the password (a storage area that cannot be accessed if the password is not entered thereinto. Thus, a processing time can be made shorter than when image data having a large data amount is encrypted/decrypted.

While a case where it is determined that the selected document data has been encrypted with the password has been handled in the above-mentioned exemplary embodiment, other determinations may be performed. For example, it may be determined whether the selected document data has been stored in a storage area that has been protected with the password in the HDD 208. In this case, a password used in accessing the storage area is diverted as a key for encryption of rasterized image data.

It may be determined whether the user, who has selected document data during printing, has a printing authority of the document data. In this case, reprinting is permitted only when a user who has issued an instruction to perform printing using a printing function and a user who has issued an instruction to perform reprinting from a printing history match each other.

While a form of reading out and printing document data from the HDD 208 and other storage devices has been handled in the above-mentioned exemplary embodiment, the present exemplary embodiment is also applicable to a form of printing print data received from a personal computer.

The present exemplary embodiment is also implemented by performing processing described below. More specifically, software (a program) for implementing the function of the above-mentioned exemplary embodiment is supplied to a system or an apparatus via a network or various types of storage media, and a computer (or a CPU, or an MPU) in the system or the apparatus reads out and executes the program.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-122904 filed May 30, 2012, which is hereby incorporated by reference herein in its entirety.

What is claimed is:

1. An image forming apparatus comprising:
an obtaining unit configured to obtain document data to be printed;
a determination unit configured to determine whether printing of the document data is permitted based on authentication information received from a user, in a case where a security setting is set on the document data;
a printing unit configured to print bitmap image data, which is generated from the document data, when the determination unit determines that the printing of the document data is permitted;
a storage unit configured to store the bitmap image data in association with a history of printing of the document data; and
a control unit configured to, when a reprint request of the document data is input based on the history, control the printing unit to print the bitmap image data stored in the storage unit in response to reception of the authentication information from the user again.

2. The image forming apparatus according to claim 1, further comprising:
an encryption unit configured to encrypt the bitmap image data using the received authentication information after the printing unit prints the bitmap image; and
a decryption unit configured to decrypt the encrypted bitmap image data in response to reception of the authentication information, when the reprint request of the document data is input based on the history.

3. The image forming apparatus according to claim 1, wherein the determination unit receives a password as the authentication information.

4. The image forming apparatus according to claim 1, wherein the document data is Portable Document Format (PDF) file.

5. The image forming apparatus according to claim 1, wherein the document data is stored in the storage unit.

6. A method for controlling an image forming apparatus, the method comprising:
obtaining document data to be printed;
determining whether printing of the document data is permitted based on authentication received from a user, in a case where a security setting is set on the document data;
printing bitmap image data, which is generated from the document data, when it is determined that the printing of the document data is permitted;
storing the bitmap image data in storage unit in association with a history of printing of the document data by the printing unit; and
printing, when a reprint request of the document data is input based on the history, the bitmap image data stored in the storage unit in response to reception of the authentication information from the user again.

7. A computer-readable storage medium storing a program that causes a computer to perform the method according to claim 6.
